(19) United States
(12) Patent Application Publication
(10) Pub. No.: US 2026/0276541 A1
(43) Pub. Date: Sep. 17, 2026

(54) DETERMINING A REFRACTIVE INDEX FOR INFRARED WAVELENGTH RANGES

(71) Applicant: University of Central Florida Research Foundation, Inc., Orlando, FL (US)

(72) Inventors: Andrew HOWE, Orlando, FL (US); Kathleen A. RICHARDSON, Orlando, FL (US); Romain GAUME, Orlando, FL (US)

(73) Assignee: University of Central Florida Research Foundation, Inc., Orlando, FL (US)

(21) Appl. No.: 19/564,156

(22) Filed: Mar. 11, 2026

Related U.S. Application Data
(60) Provisional application No. 63/771,623, filed on Mar. 13, 2025.

(51) Int. Cl. G01N 21/41; G01N 21/3563; G01N 21/3581

(52) U.S. Cl. CPC G01N 21/4133; G01N 21/3563; G01N 21/3581; G01N 2201/06113

(57) ABSTRACT

In some implementations, a system may comprise a measurement device and a computing device. The measurement device may determine a wavevector associated with the light entering a prism, determine an air gap between a bottom surface of the prism and a medium, determine an entrance angle of the light entering the prism, determine a reflection angle of reflection between interfaces associated with the prism, and determine an interface angle between the prism and an interface. The computing device may determine a refractive index of the medium based on the wavevector, the air gap, the entrance angle, the reflection angle, and the interface angle, and perform an action using the medium based on the refractive index of the medium.

### BACKGROUND

Various methods are used to evaluate characteristics of mediums in optical contexts, such a refractive index of the materials. A refractive index, of a medium, is a ratio (or quotient) of the speed of light in the medium to the speed of light in air or vacuum. The refractive index determines how much the path of light is bent, or refracted, when entering the medium. The refractive index may be referred to as a refraction index or an index of refraction.

### SUMMARY

A method comprising: determining, by a measurement device, a wavevector associated with light entering a prism; determining, by the measurement device, an air gap between a bottom surface of the prism and a medium; determining, by the measurement device, an entrance angle of the light entering the prism; determining, by the measurement device, a reflection angle of reflection between interfaces associated with the prism; determining, by the measurement device, an interface angle between the prism and an interface between the prism and a measured surface; determining, by a computing device, a refractive index of the medium based on the wavevector, the air gap, the entrance angle, the reflection angle, and the interface angle; and performing, by the computing device, an action using the medium based on the refractive index of the medium.

A system comprising: a laser device to emit light; a measurement device to: determine a wavevector associated with the light entering a prism, determine an air gap between a bottom surface of the prism and a medium, determine an entrance angle of the light entering the prism, determine a reflection angle of reflection between interfaces associated with the prism, determine an interface angle between the prism and an interface; and a computing device to: determine a refractive index of the medium based on the wavevector, the air gap, the entrance angle, the reflection angle, and the interface angle.

A non-transitory computer-readable medium storing a set of instructions, the set of instructions comprising: one or more instructions that, when executed by one or more processors of a device, cause the device to: determine a wavevector associated with light entering a prism; determine an air gap between a bottom surface of the prism and a medium; determine an entrance angle of the light entering the prism; determine a reflection angle of reflection between interfaces associated with the prism; determine an interface angle between the prism and an interface; determine a refractive index of the medium based on the wavevector, the air gap, the entrance angle, the reflection angle, and the interface angle; and perform an action using the medium based on the refractive index of the medium.

### BRIEF DESCRIPTION OF THE DRAWINGS

FIG. 1 is a diagram illustrating an example implementation described herein.

FIG. 2 is a flowchart of an example process relating to determining a refractive index.

FIG. 3 is a diagram of an example environment in which systems and/or methods described herein may be implemented.

FIG. 4 is a diagram of example components of one or more devices of FIG. 3.

FIG. 5 is a flowchart of an example process relating to determining a refractive index.

### DETAILED DESCRIPTION

The following detailed description of example implementations refers to the accompanying drawings. The same reference numbers in different drawings may identify the same or similar elements.

The refractive index is a unitless quantity that describes how light propagates through a medium. The refractive index may be specified in optical designs and is essential for applications requiring high precision, such as lens design, telecommunications, crystal growth, impurity characterization, and infrared systems. Such applications rely on reduced deviations when measuring the refractive index to ensure performance and quality control. The applications may include crystal growth conditions, impurity characterization/striae, among other examples.

The refractive index may be measured for optical systems. The optical systems may operate at different temperatures, different pressures, different wavelengths, among other examples. Measurements of the refractive index are dependent on multiple factors, including wavelength of light, temperature, pressure, manufacturing methods, and material properties. These factors can introduce deviations and variability in the results.

These multiple factors create deviations with respect to the measurements of the refractive index. Some measurement techniques have been identified for achieving reduced deviations. The measurement techniques include minimum of deviation, ellipsometry, interferometer, and prism coupling. Each measurement technique has limitations. Minimum of deviation is a time-consuming process. Additionally, minimum of deviation is a costly process (e.g., with respect to the cost of fabricating the prism). Interferometer requires parallel plates. Ellipsometry involves the use of models. However, the models do not accurately represent the optical systems.

Critical angle refractometry is a simple and effective way to measure the refractive index of a medium. Prism coupling refractometry is a technique within critical angle refractometry that uses a high index prism to measure a guided wave in a lower index substrate. For example, a sample is pressed against the high index prism in prism coupling, and the light reflected from this interface is measured. For instance, the high index prism is rotated until a detector does not detect any reflected light. The angle at which this change occurs is the critical angle.

As used herein, ‘prism coupling refractometry’ refers to a technique for measuring the refractive index of a medium by coupling a sample with a high-index prism and analyzing the light reflected from the interface between the prism and the sample. In this method, a sample with a polished flat surface is pressed against the prism, and light is directed into the prism. The system measures reflected power as a function of angle, and a critical angle is identified based on a marked change in reflected power. This critical angle enables back-calculation of the refractive index of the sample. Unlike minimum deviation or ellipsometry techniques, prism coupling refractometry does not require fabrication of a prism from the sample material and is compatible with both bulk and thin film samples, including those used for infrared applications.

At the critical angle, a sudden change may exist in the reflected power from the interface, allowing a user to use a computing device to back-calculate the refractive index of a selected medium. In some situations, a manual linear interpolation (e.g., a linear interpolation) or first derivative techniques may be used to determine the critical angle. For example, the user may use the computing device to select two points before and after the critical angle. Software (executing on the computing device) then draws lines between these points and calculates the refractive index based on their intersection. However, these methods may rely on user-selected points and can be subject to variability and inconsistency, and may not adequately account for sample absorption or scattering.

Calculating the refractive index using a linear interpolation subjects the calculated refractive index to a substantial standard of deviation. Additionally, current techniques for measuring a refractive index do not address infrared wavelengths (e.g., mid-range infrared wavelengths, long-range infrared wavelengths). Accordingly, a need exists for a technique of calculating the refractive index while decreasing the standard of deviation of the measurement. Furthermore, a need exists for a technique of calculating the refractive index for infrared wavelengths.

As used herein, ‘mid-range infrared wavelengths’ or ‘mid-wave infrared wavelengths’ refer to electromagnetic wavelengths in the range of approximately 3 micrometers (μm) to 5 μm. ‘Long-range infrared wavelengths’ or ‘long-wave infrared wavelengths’ refer to electromagnetic wavelengths in the range of approximately 8 μm to 14 μm. These definitions are intended to encompass the commonly accepted spectral regions for mid-wave and long-wave infrared applications in optical systems.

Implementations described herein are directed to improved techniques that decrease the standard deviation of refractive index measurements and extend their applicability to infrared wavelengths, thereby enhancing precision and repeatability for a wide range of optical systems and materials. For example, implementations described herein are directed to a technique for decreasing the standard of deviation of the measurement of a refractive index. The technique may involve using an assembly of components of prism coupling to determine the critical angle, as described herein. The assembly of components may be modified to determine a refractive index for infrared wavelengths, such mid-range wavelength and long-range wavelength.

Implementations described herein are directed to a system that determines a refractive index of a medium. In some examples, the system may include a prism coupling refractometry assembly, a laser, a measurement device, and a computing device. The prism coupling refractometry assembly may include a prism, a medium, and a coupling head. The laser may emit infrared light in different ranges of wavelengths, including mid-range infrared wavelengths and long-range infrared wavelength. The measurement device may measure angles associated with the light and the prism along with an air gap between the prism and the medium. The computing device generate an equation to a refractive index of the medium and fit a result of the equation using a non-linear fit function.

In this regard, some implementations described herein are directed to using the equation to determine the refractive index of the medium. In some examples, the equation may include a Fresnel equation. A result of the equation may be fitted using a non-linear fit function. For example, the non-linear fit function may be used on the equation using parameters of the equation. In some examples, the non-linear fit function may be implemented using computer code of the computing device.

In this regard, implementations described herein are directed to a computer system and software that allow a user to fully fit output data from the assembly of components. Implementations described herein allow the user to determine the refractive index of a piece of material with an improved order of magnitude and greater precision (e.g., improved with respect to existing techniques). This enhances the refractometry technique and makes the refractometry technique more applicable in an industrial setting (e.g., an optical system in the industrial setting). Overall, implementation described herein reduces the standard of deviation of measurements of refractive indices performed using existing techniques.

Some implementations described herein provide a method for determining the refractive index of a medium using a measurement device and a computing device in a prism coupling refractometry system. For example, the measurement device determines a wavevector associated with light entering a prism, an air gap between the prism and the medium, an entrance angle of the light, a reflection angle between interfaces, and an interface angle at the prism-medium boundary. The computing device then determines the refractive index of the medium based on these parameters, which are used as variables in a Fresnel equation. In some aspects, the refractive index is determined by fitting the Fresnel equation to measured data using a nonlinear fitting algorithm, where the fitting includes two constants to account for system losses. The method may further include determining tangential and normal components of the wavevector, calculating reflected power from the interface using the Poynting vector, and accommodating measurements at mid-wave or long-wave infrared wavelengths with polarized light in the transverse electric direction. The determined refractive index can be used to inform actions such as including the medium in an optical system.

In this way, the method addresses limitations of prior approaches that rely on manual linear interpolation or first derivative techniques, which may be subject to user variability, do not account for absorption or scattering, and may not provide sufficient precision or repeatability. By employing a physics-based fitting procedure using the Fresnel equations and a nonlinear algorithm, the method enables consistent and accurate identification of the critical angle and calculation of refractive index across diverse materials and experimental conditions, including those with modest attenuation or in the infrared spectral region. This approach reduces measurement variability and standard deviation and improves repeatability by minimizing the impact of manual intervention and user-dependent errors. Furthermore, the method supports refractive index determination to multiple decimal places, thereby facilitating high-precision optical characterization. In this way, the method may conserve processing resources and memory resources by automating the refractive index determination process and reducing the need for repeated measurements or manual recalculations, while also enabling efficient and reliable data analysis for optical system design and material certification.

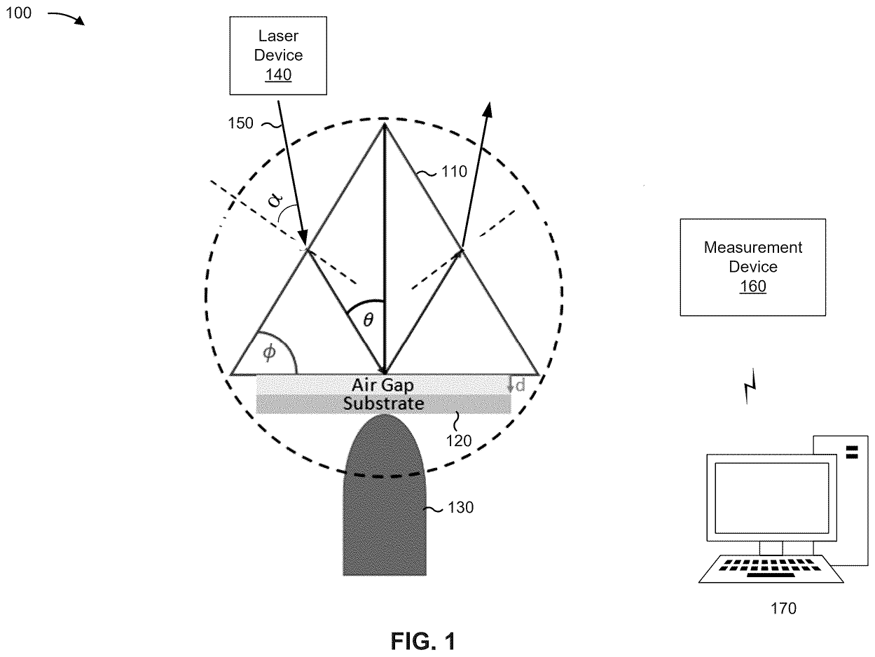

FIG. 1 is a diagram illustrating an example implementation 100 described herein. As shown in FIG. 1, implementation 100 may include a prism 110, a substrate 120, a coupling head 130. Prism 110 may be referred to as a coupling prism. Substrate 120 may include a medium of different types of material. In some implementations, coupling head 130 may press substrate 120 against prism 110. In some examples, prism 110, substrate 120, and coupling head 130 may form a prism coupling refractometry assembly.

In some implementations, the substrate to be measured comprises a bulk material having a single optically polished flat surface. The surface should be prepared to an optical flatness of better than λ/10 at the measurement wavelength, with a surface roughness less than 5 nm RMS, and cleaned to remove any contaminants prior to measurement. The minimum substrate thickness is preferably at least 1 mm to ensure mechanical stability during pressing against the prism. Substrate lateral dimensions may be up to 25 mm×25 mm, limited by the capacity of the prism coupling assembly. In cases where smaller samples are used, the practitioner should ensure the sample fully covers the contact area of the prism to avoid edge effects. Measurements are preferably performed under ambient laboratory conditions, with temperature maintained between 20° C. and 25° C. and relative humidity below 60%. Any deviation from these parameters may affect the accuracy and repeatability of refractive index determination. The practitioner should calibrate the system using a standard material of known refractive index prior to measurement, and ensure the air gap between prism and substrate is minimized but non-zero (typically less than 5 μm), as determined by the measurement device.

In some implementations, coupling head 130 comprises a mechanical fixture configured to apply uniform, controlled pressure to substrate 120, thereby ensuring consistent optical contact with prism 110 during measurement. The coupling head 130 may include a spring-loaded mount, adjustable clamp, or micrometer-driven actuator, allowing for fine adjustment of the applied force to account for substrates of varying thickness and mechanical properties. The contact surface of coupling head 130 may be lined with a compliant material, such as polytetrafluoroethylene (PTFE) or silicone rubber, to distribute pressure evenly across the substrate and prevent surface damage. In certain embodiments, coupling head 130 incorporates an integrated force sensor or gauge, enabling the user to monitor and set the contact pressure within a specified range (e.g., 0.2-2 N), thereby minimizing the air gap to less than 5 μm, as determined by the measurement device. The coupling head may be mounted on a translation stage to facilitate precise alignment of the substrate relative to the prism. These features ensure that the optical and mechanical interface between substrate 120 and prism 110 is reproducible, stable, and suitable for high-precision refractive index measurements across different sample types.

As shown in FIG. 1, implementation 100 may include a laser device 140 that emits light 150. In some examples, laser device 140 may include a diode, a mid-wave infrared laser, a quantum cascade laser, a CO₂ laser, among other examples. In some examples, light may include an infrared light. In some examples, laser device 140 may emit light in mid-range infrared wavelengths and long-range infrared wavelengths. In this regard, a wavelength of light 150 may be included in mid-range infrared wavelengths and long-range infrared wavelengths.

As shown in FIG. 1, implementation 100 may include a measurement device 160 and a computing device 170. In some examples, measurement device 160 may measure angles associated with light 150 and prism 110 along with an air gap between prism 110 and substrate 120. In some implementations, measurement device 160 may include a sensor device, a digital angle gauge and level, a digital angle finder with a laser, a digital tape measure, among other examples. In some examples, measurement device 160 may measure an angle α, which is an entrance angle of light 150 for prism 110. Additionally, or alternatively, measurement device 160 may measure an angle θ, which is the angle of reflection between interfaces. The interfaces may include a back surface of prism 110 and a front surface of the material being measured. Additionally, or alternatively, measurement device 160 may measure an angle Φ, which is the angle that prism 110 makes with the interface. Additionally, or alternatively, measurement device 160 may measure a distance d, which is an airgap between surfaces.

Computing device 170 includes one or more devices capable of receiving, generating, storing, processing, and/or providing information described herein and/or in the appendix. Computing device 170 may include a communication device and/or a computing device. For example, computing device 170 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device.

In some examples, computing device 170 may include a server, an application server, a client server, a web server, a database server, a host server, a proxy server, a virtual server (e.g., executing on computing hardware), a server in a cloud computing system, a device that includes computing hardware used in a cloud computing environment, or a similar type of device.

In some implementations, computing device 170 may establish a connection (e.g., wired or wireless) with measurement device 160. In this regard, computing device 170 may cause (e.g., provide instructions to cause) measurement device 160 to perform the operations described herein.

In some implementations, computing device 170 may include computer code to determine a refractive index of a medium, such as substrate 120, as explained herein. For example, computing device 170 may include computer code to use values (obtained by measurement device 160) in an equation (e.g., a Fresnel equation) to determine the refractive index, as described herein. Computing device 170 may include computer code to fit a result of the equation in a non-linear fit function, as described herein.

In this regard, light 150 may be polarized in a transverse electric (TE) direction with respect to the interface. The prism Fresnel equations are derived as follows:

$${k}_{tan , air} = {k}_{0} sin ( α ) \qquad ( 2 )$$

$${k}_{norm , a i r} = {k}_{0} \sqrt{{n}_{p}^{2} - {sin}^{2} ( α )} \qquad ( 3 )$$

Where k is broken into tangential and normal components about the first interface, the tangential fields are continuous over the interface. Here, k₀ is the wavevector of free space for the incoming light, nₚ is the index of the prism and alpha (a) is the angle which the incident beam makes with the normal of the prism interface.

Going inside the prism, the k-vector is calculated for the tangential and normal directions based on the angle the prism is cut at and the angle it makes to the normal at the prism's bottom surface. Equations 4 and 5 give the field components at the interface between the airgap and the prism's bottom face.

$${k}_{tan , p} = {k}_{n o r m , p} sin ( ϕ ) + {k}_{tan , p} cos ( ϕ ) \qquad ( 4 )$$

$${k}_{n o r m , p} = {k}_{0} \cdot \sqrt{{n}_{p}^{2} - {( {n}_{p} sin ( θ ) )}^{2}} \qquad ( 5 )$$

$$γ = {k}_{0} \cdot \sqrt{{( {n}_{p} sin ( θ ) )}^{2} - {n}_{g}^{2}} \qquad ( 6 )$$

Next, the effect of the air gap is considered. A uniform air gap is assumed and associated with the variable δ. This comes from the k-vector normal to the prism's exit face and the air gap's length. It determines how much the field can extend over this gap and interact with the substrate medium.

$$δ = γ \cdot d \qquad ( 7 )$$

$${k}_{n o r m s} = {k}_{0} \cdot \sqrt{{n}_{s}^{2} - {( {n}_{p} sin ( θ ) )}^{2}} \qquad ( 8 )$$

The reflected power from an interface comes from the Poynting vector that travels normally to that interface. This vector is calculated through the cross-product of the field components at the interface.

$$\frac{{P}_{R}}{{P}_{i}} = {\vert \frac{{k}_{i} - {k}_{T}}{{k}_{i} + {k}_{T}} \vert}^{2} \qquad ( 9 )$$

Where kᵢ and k_{T} are the incident and transmitted k-vectors for the situation. This leads to equation 10, which combines (4), (5), (6), and (7) to give the total reflected power from the interface of interest.

$${P}_{r} = {( \frac{\begin{matrix}{k}_{norm , f} ( {k}_{norm , p} - {k}_{norm , s} ) cos ( δ ) + \\ i ( {k}_{norm , p} {k}_{norm , s} - {k}_{norm , f}^{2} ) sin ( δ )\end{matrix}}{\begin{matrix}{k}_{norm , f} ( {k}_{norm , p} + {k}_{norm , s} ) cos ( δ ) + \\ i ( {k}_{norm , p} {k}_{norm , s} + {k}_{norm , f}^{2} ) sin ( δ )\end{matrix}} )}^{2} \qquad ( 10 )$$

This equation allows for the refractive index of each medium to be a complex value, and no assumption about loss is made when using this equation. However, in the case of transparent dielectric materials, which are studied, some simplifications can be made. Equation 11 may be reduced to the following if the substrate medium is assumed to be non-lossy, i.e., the refractive index is considered purely real.

$${P}_{r} = 1 - \frac{\begin{matrix}( 4 \cdot {k}_{norm , p} \cdot {k}_{norm , s} \cdot {k}_{norm , f}^{2} ) \\ [ 1 - {tanh}^{2} ( {k}_{norm , f} \cdot d ) ] )\end{matrix}}{\begin{matrix}{{k}_{norm , f}^{2} ( {k}_{norm , p} + {k}_{norm , s} )}^{2} + {( {k}_{norm , p} \cdot {k}_{norm , s} - {k}_{norm , f} )}^{2} \cdot \\ {tanh}^{2} ( {k}_{norm , f} \cdot d )\end{matrix}} \qquad ( 11 )$$

This assumes a linear, homogeneous, isotropic medium with TE polarized light incident upon the surface δ is set to zero. This equation shows a total loss of reflected power at a critical angle. This is the ideal coupling. If the gap were to become larger than the wavelength of light, then d would be large, such that the reflected power would become unity at the bottom prism air interface, and there would be no coupling. Evaluating equation 10 can be useful as it considers the real refractive indices of both media and their imaginary parts. This equation can be used to model the effect of the sample's attenuation on the measurement.

To initiate our efforts to more precisely fit the reflected power versus angle data to more effectively determine the critical angle, these equations formed the framework to code into MATLAB. We employed a nonlinear fitting algorithm to fit these equations to experimental results. While a true discontinuity may not exist in the measurement due to absorption or scatter, a large drop in reflected power should occur. To fit this equation and match it to the condition of total internal reflection, the fitted curve is used for a second derivative test wherein an inflection point is found. This inflection point is the critical angle for the sample and allows for the back calculation of the refractive index of this sample.

$$R = A \cdot {\vert \frac{cos ( θ ) - \sqrt{{( \frac{{n}_{s}}{{n}_{p}} )}^{2} - {sin}^{2} ( θ )}}{cos ( θ ) + \sqrt{{( \frac{{n}_{s}}{{n}_{p}} )}^{2} - {sin}^{2} ( θ )}} \vert}^{2} + B \qquad ( 12 )$$

The equation above is modified for the fitting procedure in MATLAB. Because there is a high index ZnSe window in front of the detector, additional loss contributions in the overall setup are likely to need to be considered. Hence, two fitting parameters are added to adjust the global reflectivity. First, a constant is multiplied by the power; this helps to account for Fresnel loss from the window or other losses in the system. Next, a constant is added to the power. This accounts for any angularly dependent losses in the system and allows the curve to converge faster than it would otherwise. Neither of these coefficients affect the measured position of the critical angle but are explained here for completeness.

In some implementations, the use of the Fresnel-based nonlinear fitting technique to analyze prism coupling refractometry data results in a significant quantitative improvement in measurement precision. For example, when applied to measurements of a plano-plano ZnSe sample at 4.5 microns, the standard deviation of refractive index measurements is reduced by two orders of magnitude compared to linear interpolation methods, from ±5×10⁻⁴ to under ±5×10⁻⁶. This enhanced precision enables certification of refractive indices to the third decimal point or better, providing results suitable for high-precision optical applications. The improved repeatability and reduced standard deviation make the system and method particularly valuable for quality control and batch-to-batch comparisons in optical manufacturing.

In previous approaches to determining the critical angle in prism coupling refractometry, a linear interpolation method was used. This involved manually selecting two points before and after the critical angle on the reflected power curve, drawing lines between these points, and identifying their intersection as the critical angle. However, this manual technique is sensitive to user selection and sample attenuation, often resulting in higher variability and less reproducible measurements. The present method replaces linear interpolation with a physics-based nonlinear fitting routine, wherein a Fresnel equation is fitted to the measured data using a nonlinear algorithm. The workflow includes providing starting values for refractive indices and window parameters, fitting the curve, and utilizing a second derivative test to locate the inflection point corresponding to the critical angle. This process is repeatable and robust against attenuation effects in the sample or system.

The prism coupling refractometry system is operated under environmentally controlled laboratory conditions, such as room temperature (approximately 23° C.), to ensure measurement consistency. Each prism is calibrated using a ZnSe witness slab referenced to a ZnSe prism measured by the minimum deviation method, providing a reliable calibration standard for accurate refractive index determination. The system setup includes a germanium prism for infrared measurements, a ZnSe plate polarizer cut at Brewster's angle, and a cryogenically cooled MCT detector. Infrared lasers spanning short-wave to long-wave infrared are used, pulsed with a frequency generator or optically chopped, with the detector output processed by a lock-in amplifier to minimize background noise. These calibration and environmental controls contribute to the improved accuracy and repeatability of the measurements.

The described technique is applicable to both planar bulk and thin film samples, offering high accuracy without requiring complex sample preparation. Unlike methods that necessitate the fabrication of a prism from the test specimen or parallel plates, prism coupling refractometry can be extended to smaller-scale samples and test melts where such fabrication is impractical. This versatility enables rapid, precise determination of refractive index for a broad range of optical materials, supporting advanced metrology and material certification.

Day-to-day repeatability of refractive index measurements can be assessed using the nonlinear fitting technique by measuring multiple locations on a sample over several days. Experimental results show that, while the standard deviation is greatly reduced with the new method, fluctuations in measured index values from day to day may still occur. These variations highlight the influence of physical or phenomenological factors beyond the fitting protocol, such as environmental changes, material properties, or system calibration, and indicate the necessity for continued refinement of the technique to further improve precision and accuracy.

As indicated above, FIG. 1 is provided as an example. Other examples may differ from what is described in connection with FIG. 1.

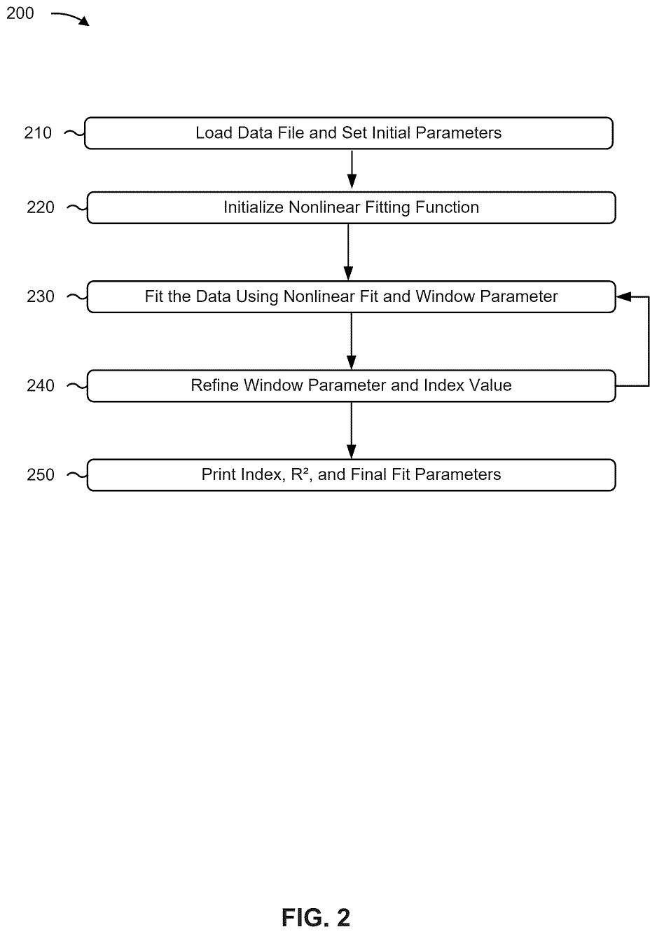

FIG. 2 is a flowchart of an example process 200 relating to determining a refractive index. In some implementations, one or more process blocks of FIG. 2 may be performed by another device or a group of devices separate from or including the computing system, such as a computing device (e.g., computing device 170) and/or a measurement device (e.g., measurement device 160).

As shown in FIG. 2, process 200 may include loading data file and setting initial parameters (block 210). For example, process 200 may begin by the computing device loading a data file and selecting relevant constants, such as wavelength (λ), prism apex angle (Ψ), substrate index (ns), and prism index (np). An initial guess for the refractive index and an initial window parameter may also be set (e.g., by the computing device). Process 200 begins with a user loading a data file, which likely contains measurement results or experimental data. The user then selects constants required for the analysis. The constants may include wavelength (λ) of light used in the experiment. Additionally, or alternatively, the constants may include the angle at the apex of the prism (e.g., Ψ or prism apex angle), which is relevant for optical path calculations. Additionally, or alternatively, the constants may include the refractive index of the substrate material (ns or substrate index). Additionally, or alternatively, the constants may include the refractive index of the prism material (np or prism index). The user also sets an initial guess for the refractive index of the sample or medium being analyzed, as well as an initial window parameter, which may define the range or sensitivity of the fitting process.

As further shown in FIG. 2, process 200 may include initializing nonlinear fitting function (block 220). For example, the next step may involve the computing device initializing a nonlinear fitting function with the initial parameters established in the previous step. With the initial parameters established, the computing device initializes a nonlinear fitting function. This function is designed to model the relationship between the measured data and the physical parameters being estimated (such as refractive index). The initialization step ensures that the fitting algorithm starts with reasonable values, improving the likelihood of convergence.

As further shown in FIG. 2, process 200 may include fitting the data using nonlinear fit and window parameter (block 230). For example, the data is then fitted using the nonlinear fitting function and the window parameter. The core of 200 process involves fitting the experimental data using the nonlinear fitting function. The window parameter is used to control aspects of the fitting, such as the data range considered or the weighting of certain data points. The fitting algorithm iteratively adjusts the parameters to minimize the difference between the measured data and the model predictions

As further shown in FIG. 2, process 200 may include refining window parameter and index value (block 240). For example, after the initial fit, the window parameter and the index value are refined to improve the fit quality. After the initial fit, the process enters a refinement stage. Here, the window parameter and the refractive index value are further adjusted to optimize the fit. This step may involve additional iterations, sensitivity analysis, or error minimization to ensure that the final parameter values are accurate and robust.

As further shown in FIG. 2, process 200 may include printing index, R², and final fit parameters (block 250). For example, process 200 concludes by printing the determined index, the R² value (which indicates the goodness of fit), and the final fit parameters. For instance, the computing device may provide (or display) the estimated refractive index or other key parameter, a statistical measure (R² (Coefficient of Determination)) indicating how well the fitted model explains the variance in the data, any additional parameters determined by the fitting process, such as window size, error metrics, or other relevant values. In some examples, higher R² values suggest a better fit.

Process 200 outlines a systematic approach for parameter estimation using nonlinear fitting techniques. Process 200 ensures that initial guesses are refined iteratively, and the results are quantitatively evaluated and reported. Process 200 ensures that parameter estimation is performed rigorously, with iterative refinement and quantitative evaluation of fit quality. The use of nonlinear fitting allows for accurate modeling of complex relationships between experimental data and physical properties.

Process 200 may include additional implementations, such as any single implementation or any combination of implementations described herein and/or in connection with one or more other processes described elsewhere herein.

In some implementations, a pseudocode associated with process 200 may be as follows:
load data file, select constants (λ, Ψ, nₛ, nₚ), set initial guess for index, set initial window parameter;
initialize nonlinear fitting function with initial parameters;
fit the data using nonlinear fit and window parameter
refine window parameter and index value; and
print index, R², and final fit parameters.

The user select the starting values. For example, the user may select the values for λ, Ψ, nₛ, nₚ. In this regard, λ is the wavelength, Ψ is the prism apex angle, nₛ is the index of substrates and nₚ is the index of the prism. The steps fitting the data and refining the window parameter and the index value may be repeated. For example, after performing the step of refining the window parameter and the index value, the step of fitting the data may be performed. After performing the step of fitting the data, the step of refining the window parameter and the index value may be performed, and so on. The window parameter may be corresponding to the angular acceptance range for the instrument however it is calculated using Snell's law to convert a range of angle values to a range of index values. This maps an angular range to an index range for the fit. The print index may be the part of the code “print index”. It just outputs the number on the gui for the user. R\hat{ }2 is the goodness of fit parameter and final fit parameters are the values that were used for the final fit with the best r\hat{ }2 results. This line just put the output of the algorithm in a nice chart for the user to review.

The ideal way to use this code is to find the inflection point and then create a loop around this portion, increasing the range of angles evaluated. This allows the user to select a consistent refractive index and critical angle.

This fit's convergence was checked to see if the non-linear fitting procedure produced repeatable results given different amounts of data. The figure below shows the reported critical angle as a function of the fitting window size. Here, the fitting window size is the range of data that is used for the fit in degrees.

This is because the nonlinear fit itself is local to the region around the inflection point. The reflected power curve is scanned for an ideal window that is defined by the minimum critical angle shown in the figure. This convergence occurs with each fit and is how the inflection point is truly defined. By varying the critical angle, the user can find a global minimum for the critical angle. This minimum is defined as the true critical angle that is then used to calculate the refractive index of the ZnSe.

In some implementations, the measurement device is configured to acquire data by sequentially rotating the prism coupling assembly about the interface axis. The measurement device, which may comprise a digital angle gauge and level, obtains the entrance angle of the incident light relative to the prism surface, the reflection angle at the prism-medium interface, and the interface angle between the prism and the measured substrate. Prior to measurement, the substrate is prepared by polishing a single flat surface to optical quality (surface roughness less than 50 Angstroms RMS), ensuring direct contact with the prism via the coupling head. The air gap between the prism and substrate is measured using a digital tape measure or micrometer, and typically maintained below the wavelength of the incident infrared light to maximize coupling efficiency. The assembly is calibrated by referencing the prism index via a witness slab, measured by minimum deviation, and the environmental conditions (temperature, humidity) are logged for each run.

Upon data acquisition, the computing device receives the measured parameters and initiates a nonlinear fitting routine, typically implemented in MATLAB or equivalent software. The fitting algorithm utilizes the Fresnel equations, inputting measured values for wavelength (λ), prism apex angle (Ψ), substrate refractive index (ns), prism refractive index (np), air gap (d), and the angular window size. The user selects initial guesses for ns and window parameters, then the algorithm scans the reflected power curve across a range of angles, utilizing a second derivative test to locate the inflection point corresponding to the critical angle. The fitting window size is iteratively adjusted by the software to converge on a global minimum of the critical angle, with the goodness-of-fit (R\hat{ }2) and final parameter values displayed to the user. The process may be repeated for multiple locations on the substrate, or for multiple substrates, to assess repeatability and batch-to-batch variation. The refractive index determined by this process is output as a chart and may be utilized for subsequent actions, such as inclusion of the medium in an optical system.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

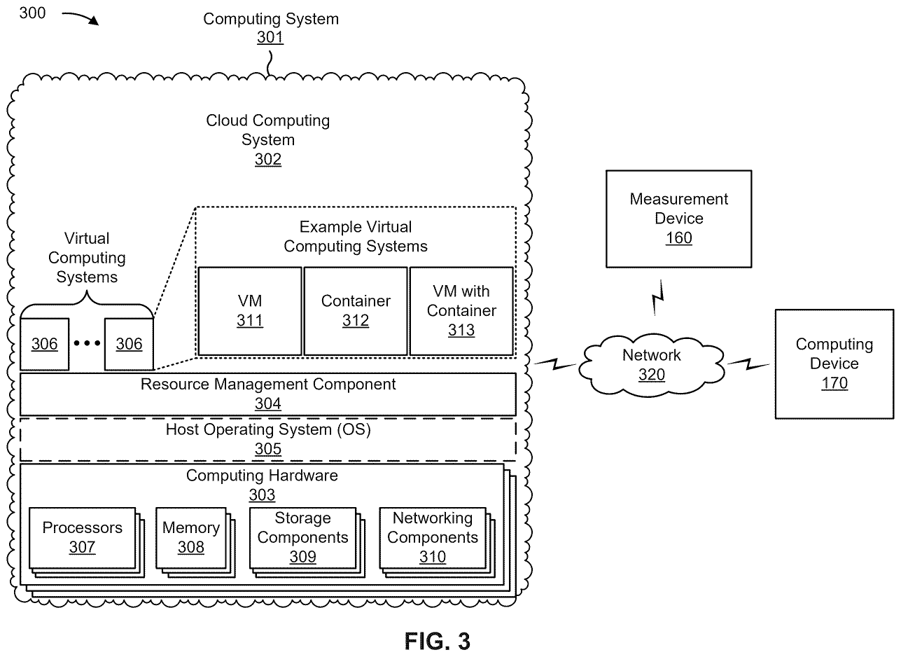

FIG. 3 is a diagram of an example environment 300 in which systems and/or methods described herein may be implemented. As shown in FIG. 3, environment 300 may include a computing system 301, which may include one or more elements of and/or may execute within a cloud computing system 302. The cloud computing system 302 may include one or more elements 303-213, as described in more detail below. As further shown in FIG. 3, environment 300 may include a network 220, measurement device 160, computing device 170, and/or other devices described in the appendix. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 410. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 211. Additionally, or alternatively, the resource management component 304 may include a container manager, such as when the virtual computing systems 306 are containers 212. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 211, a container 212, a hybrid environment 113 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

Although the computing system 301 may include one or more elements 303-213 of the cloud computing system 302, may execute within the cloud computing system 302, and/or may be hosted within the cloud computing system 302, in some implementations, the computing system 301 may not be cloud-based (e.g., may be implemented outside of a cloud computing system) or may be partially cloud-based. For example, the computing system 301 may include one or more devices that are not part of the cloud computing system 302, such as device 400 of FIG. 3, which may include a standalone server or another type of computing device. The computing system 301 may perform one or more operations and/or processes described in more detail elsewhere herein.

Network 420 includes one or more wired and/or wireless networks. For example, network 420 may include a cellular network, a public land mobile network (PLMN), a local area network (LAN), a wide area network (WAN), a private network, the Internet, and/or the like, and/or a combination of these or other types of networks. The network 420 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

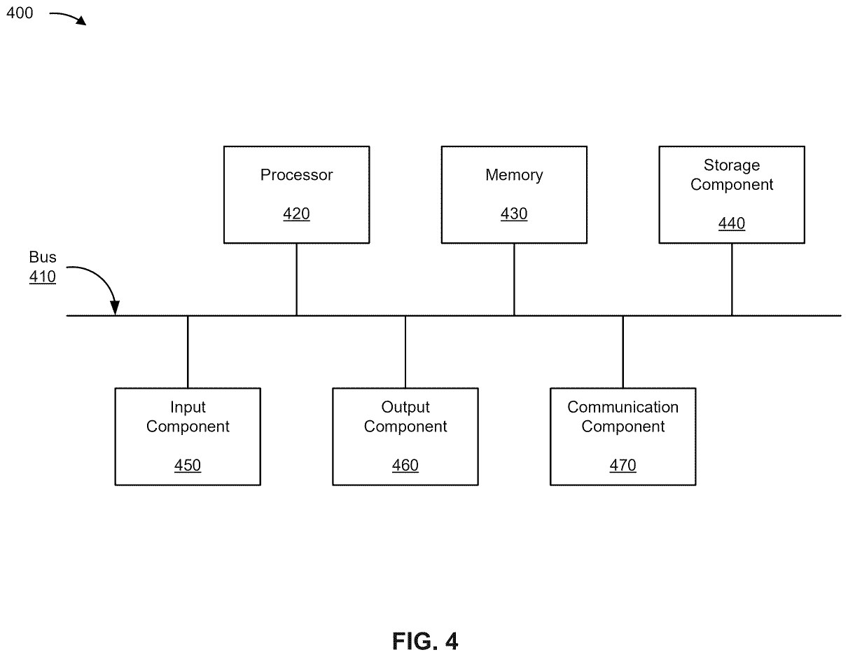

FIG. 4 is a diagram of example components of a device 400, which may correspond to computing system 301, computing device 170, and/or measuring device 160. In some implementations, computing system 301, computing device 170, and/or measuring device 160 may include one or more devices 300 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

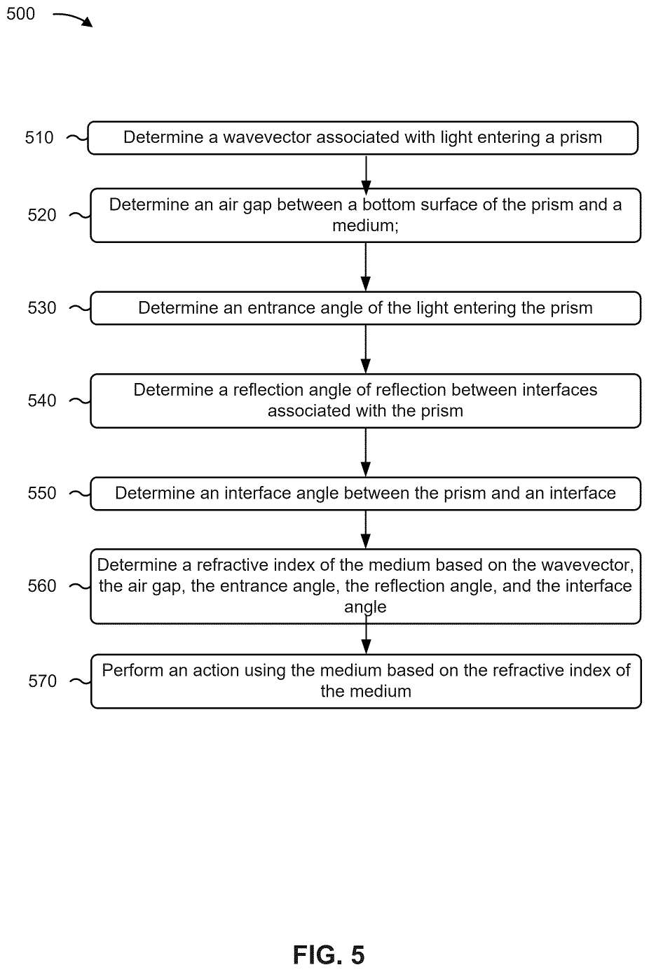

FIG. 5 is a flowchart of an example process 500 relating to determining a refractive index. In some implementations, one or more process blocks of FIG. 5 may be performed by a computing system (e.g., computing system 301). In some implementations, one or more process blocks of FIG. 5 may be performed by another device or a group of devices separate from or including the computing system, such as a computing device (e.g., computing device 170) and/or a measurement device (e.g., measurement device 160). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include determining a wavevector associated with light entering a prism (block 510). For example, the computing system may determine a wavevector associated with light entering a prism, as described above.

As further shown in FIG. 5, process 500 may include determining an air gap between a bottom surface of the prism and a medium (block 520). For example, the computing system may determine an air gap between a bottom surface of the prism and a medium, as described above.

As further shown in FIG. 5, process 500 may include determining an entrance angle of the light entering the prism (block 530). For example, the computing system may determine an entrance angle of the light entering the prism, as described above.

As further shown in FIG. 5, process 500 may include determining a reflection angle of reflection between interfaces associated with the prism (block 540). For example, the computing system may determine a reflection angle of reflection between interfaces associated with the prism, as described above. As used herein, the term ‘reflection angle of reflection between interfaces associated with the prism’ refers to the angle formed between the direction of the incident light and the normal to the interface at which reflection occurs, specifically at the boundary between the prism and the adjacent medium. This angle is measured by the measurement device and corresponds to the physical angle at which reflected power is detected in the prism coupling refractometry setup. For clarity, the reflection angle is the angle of incidence at the prism-medium interface, which determines the onset of total internal reflection and is used in the calculation of the refractive index as described herein.

As further shown in FIG. 5, process 500 may include determining an interface angle between the prism and an interface (block 550). For example, the computing system may determine an interface angle between the prism and an interface, as described above.

As further shown in FIG. 5, process 500 may include determining a refractive index of the medium based on the wavevector, the air gap, the entrance angle, the reflection angle, and the interface angle (block 560). For example, the computing system may determine a refractive index of the medium based on the wavevector, the air gap, the entrance angle, the reflection angle, and the interface angle, as described above.

As further shown in FIG. 5, process 500 may include performing an action using the medium based on the refractive index of the medium (block 570). For example, the computing system may perform an action using the medium based on the refractive index of the medium, as described above.

In some implementations, performing an action using the medium based on the refractive index of the medium comprises incorporating the medium into an optical system if the refractive index meets a predefined threshold, adjusting system parameters for optimal performance based on the measured refractive index, or recording the refractive index in a database for material certification and traceability. The action may further include selecting the medium for use in an optical device, calibrating an optical instrument, or verifying material quality, wherein the refractive index value determines the suitability of the medium for a specific optical application.

Process 500 may include additional implementations, such as any single implementation or any combination of implementations described herein and/or in connection with one or more other processes described elsewhere herein.

In some implementations, determining the refractive index comprises determining the refractive index using a Fresnel equation, and wherein variables, of the Fresnel equation, include the wavevector, the air gap, the entrance angle, the reflection angle, the interface angle.

In some implementations, determining the refractive index using the Fresnel equation comprising fitting the Fresnel equation using a nonlinear fitting algorithm.

In some implementations, fitting the Fresnel equation using the nonlinear fitting algorithm comprises using the nonlinear fitting algorithm based on two fitting parameters, wherein the two fitting parameters includes two constants, and wherein the two fitting parameters are used to account for system losses.

In some implementations, the light is infrared light emitted by one or more infrared lasers, and wherein a wavelength of the infrared light is included in a mid-wage infrared wavelength or a long-wave infrared wavelength.

In some implementations, determining the wavevector comprises determining a tangential component and a normal component of the wavevector, and wherein determining the refractive index comprises determining the refractive index based on the tangential component and the normal component.

In some implementations, process 500 includes determining a reflected power from the interface based on a Poynting vector that travels normally to the interface.

In some implementations, determining the wavevector comprises determining the wavevector for tangential and normal directions based on an angle associated with the prism, and wherein determining the refractive index of the medium comprises determining the refractive index as a function of at least one of wavelength or temperature.

In some implementations, the light is polarized in the transverse electric (TE) direction with respect to the interface.

In some implementations, performing the action comprises causing the medium to be included in an optical system based on a value of the refractive index.

In some examples, determining the refractive index of the medium comprises determining the refractive index as a function of at least one of wavelength or temperature. In some examples, determining the refractive index does not require fabricating a prism or parallel plate from the medium. In some examples, the system comprises an infrared-compatible polarizer, (b) the system comprises an optical chopper and a lock-in amplifier, (c) the system comprises an integrating sphere and a cooled infrared detector, or (d) the prism comprises germanium

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
determining, by a measurement device, a wavevector associated with light entering a prism;
determining, by the measurement device, an air gap between a bottom surface of the prism and a medium;
determining, by the measurement device, an entrance angle of the light entering the prism;
determining, by the measurement device, a reflection angle of reflection between interfaces associated with the prism;
determining, by the measurement device, an interface angle between the prism and an interface between the prism and a measured surface;
determining, by a computing device, a refractive index of the medium based on the wavevector, the air gap, the entrance angle, the reflection angle, and the interface angle; and
performing, by the computing device, an action using the medium based on the refractive index of the medium.

2. The method of claim 1, wherein determining the refractive index comprises:
determining the refractive index using a Fresnel equation, and
wherein variables, of the Fresnel equation, include the wavevector, the air gap, the entrance angle, the reflection angle, the interface angle.

3. The method of claim 2, wherein determining the refractive index using the Fresnel equation comprising:
fitting the Fresnel equation using a nonlinear fitting algorithm.

4. The method of claim 3, wherein fitting the Fresnel equation using the nonlinear fitting algorithm comprises:
using the nonlinear fitting algorithm based on two fitting parameters,
wherein the two fitting parameters includes two constants, and
wherein the two fitting parameters are used to account for system losses.

5. The method of claim 1, wherein the light is infrared light emitted by one or more infrared lasers, and
wherein a wavelength of the infrared light is included in a mid-wage infrared wavelength or a long-wave infrared wavelength.

6. The method of claim 1, wherein determining the wavevector comprises:
determining a tangential component and a normal component of the wavevector; and
wherein determining the refractive index comprises:
determining the refractive index based on the tangential component and the normal component.

7. The method of claim 1, further comprising:
determining a reflected power from the interface based on a Poynting vector that travels normally to the interface.

8. The method of claim 1, wherein determining the wavevector comprises:
determining the wavevector for tangential and normal directions based on an angle associated with the prism, and
wherein determining the refractive index of the medium comprises:
determining the refractive index as a function of at least one of wavelength or temperature.

9. The method of claim 1, wherein the light is polarized in the transverse electric (TE) direction with respect to the interface.

10. The method of claim 1, wherein performing the action comprises:
causing the medium to be included in an optical system based on a value of the refractive index.

11. A system comprising:
a laser device to emit light;
a measurement device to:
determine a wavevector associated with the light entering a prism,
determine an air gap between a bottom surface of the prism and a medium,
determine an entrance angle of the light entering the prism,
determine a reflection angle of reflection between interfaces associated with the prism,
determine an interface angle between the prism and an interface; and
a computing device to:
determine a refractive index of the medium based on the wavevector, the air gap, the entrance angle, the reflection angle, and the interface angle.

12. The system of claim 11, wherein, to determine the refractive index, the computing device is to:
determine the refractive index using a Fresnel equation, and
wherein variables, of the Fresnel equation, include the wavevector, the air gap, the entrance angle, the reflection angle, the interface angle.

13. The system of claim 12, wherein the computing device is further to:
fit the Fresnel equation using a nonlinear fitting algorithm.

14. The system of claim 13, wherein, to fit the Fresnel equation using the nonlinear fitting algorithm, the computing device is to:
use the nonlinear fitting algorithm based on two fitting parameters,

15. The system of claim 11, wherein the laser device is an infrared laser,
wherein the light is infrared light, and
wherein a wavelength of the infrared light is included in a mid-wage infrared wavelength or a long-wave infrared wavelength.

16. The system of claim 11, wherein the light is polarized in the transverse electric (TE) direction with respect to the interface.

17. The system of claim 11, wherein the computing device is further to:
cause the medium to be included in an optical system based on a value of the refractive index.

18. A non-transitory computer-readable medium storing a set of instructions, the set of instructions comprising:
one or more instructions that, when executed by one or more processors of a device, cause the device to:
determine a wavevector associated with light entering a prism;
determine an air gap between a bottom surface of the prism and a medium;
determine an entrance angle of the light entering the prism;
determine a reflection angle of reflection between interfaces associated with the prism;
determine an interface angle between the prism and an interface;
determine a refractive index of the medium based on the wavevector, the air gap, the entrance angle, the reflection angle, and the interface angle; and
perform an action using the medium based on the refractive index of the medium.

19. The non-transitory computer-readable medium of claim 17, wherein the light is polarized in the transverse electric (TE) direction with respect to the interface, and
wherein the medium comprises a bulk material having a single optically polished flat surface.

20. The non-transitory computer-readable medium of claim 17, wherein the light is infrared light emitted by one or more infrared lasers, and
wherein a wavelength of the infrared light is included in a mid-wage infrared wavelength or a long-wave infrared wavelength.
